(19) United States
(12) Patent Application Publication
(10) Pub. No.: US 2004/0197364 A1
(43) Pub. Date: Oct. 7, 2004

(54) Topical insect repellent

(76) Inventor: Paul R. Brown, New York, NY (US)

Correspondence Address: WIGGIN AND DANA LLP, ATTENTION: PATENT DOCKETING, ONE CENTURY TOWER, P.O. BOX 1832, NEW HAVEN, CT, 06508-1832, US

(21) Appl. No.: 10/756,246

(22) Filed: Jan. 13, 2004

Related U.S. Application Data
(60) Provisional application No. 60/442,406, filed on Jan. 24, 2003.

(51) Int. Cl. A01N 65/00; A01N 25/00

(52) U.S. Cl. 424/405; 424/742; 424/747; 424/744; 424/757; 424/769

(57) ABSTRACT

The present invention is directed to a topical insect repellent composition, comprising: 40-70 wt % eucalyptus oil; 3-10 wt % catnip oil; 2-6 wt % DMSO or MSM; 6-20 wt % aloe vera; 6-20 wt % jojoba oil; 6-20 wt % tea tree oil; and 6-20 wt % peppermint oil, all weight percents based on the total weight of the composition. The present invention is also directed to an article of manufacture that contains a label and the composition of the invention.

### CROSS-REFERENCE TO RELATED APPLICATIONS

This application claims the benefit of U.S. Provisional Application No. 60/442,406, filed on Jan. 24, 2003, the disclosure of which is incorporated by reference in its entirety.

### BACKGROUND OF THE INVENTION

1. Field of the Invention

The present invention is directed to insect repellents, and more particularly to insect repellents made from botanical oils.

2. Brief Description of the Related Art

The prior art is replete with examples of topical insect repellant compositions. However, most commercial insect repellents contain, as the primary active component, the chemical diethytoluamide (DEET). Recently, many concerns have been raised regarding the topical administration of compositions containing DEET, particularly among children. These concerns have resulted in the Environmental Protection Agency (EPA) announcing that it is now banning manufacturers from claiming any DEET-containing composition to be safe for children. Even when used properly by adults, DEET has been known to cause rashes, seizures and irritability. Accordingly, DEET-free insect repellents are finding favor with consumers, particularly insect repellents made from natural ingredients. Several of these DEET-free topical insect repellant compositions are described below:

U.S. Pat. No. 6,300,324 to Partelow discloses a composition for repelling ticks and other insects that contains a combination of plant extracts in a topical liquid carrier. The plant extracts include lavender, rosemary, thyme, aloe vera, and eucalyptus, as well as various vitamins.

U.S. Pat. No. 5,965,137 to Petrus discloses a topical composition for the delivery of bioaffecting agents through the protective outer layer of skin into the underlying tissues and into the general circulation to prevent the causes and symptoms of vector-borne diseases. The transdermal penetration is achieved by the use of an essential volatile oil with insect repellent capabilities, such as eucalyptus oil.

U.S. Pat. No. 6,284,227 to Stewart discloses a water resistant sunscreen and insect repellent composition that includes a sunscreen agent, an insect repellent, including p-menthane-3,8-diol, an emulsifying agent, and a film former, all in an aqueous solvent

U.S. Pat. No. 5,885,600 to Blum et al. discloses an insect repellent composition that is made from cold processed extracted oils and an antioxidant, particularly from a combination of neem, citronella and cedarwood oils.

U.S. Pat. No. 5,776,477 to Ryder discloses a variable mixture of natural ingredients including pennyroyal herb, tansy herb, calendula, citronella, pyrethrin and aloe vera.

U.S. Pat. No. 5,801,196 to Manker et al. discloses a method for repelling biting insects such as mosquitoes by topically applying to the skin of a subject fractions of emu oil.

Additional DEET-free insect repellents would be desirable in the marketplace.

### SUMMARY OF THE INVENTION

In one aspect, the present invention is directed to a topical insect repellent composition, comprising: 40-70 wt % eucalyptus oil; 3-10 wt % catnip oil; 2-6 wt % DMSO or MSM; 6-20 wt % aloe vera; 6-20 wt % jojoba oil; 6-20 wt % tea tree oil; and 6-20 wt % peppermint oil, all weight percents based on the total weight of the composition.

In another aspect, the present invention is directed to an article of manufacture comprising packaging material and a topical insect repellent contained within the packaging material, wherein the topical insect repellent is effective for repelling insects from the skin or clothing, and wherein the packaging material comprises a label which indicates that the topical insect repellent can be used for repelling insects from the skin or clothing, and wherein the topical insect repellent comprises: 40-70 wt % eucalyptus oil; 3-10 wt % catnip oil; 2-6 wt % DMSO or MSM; 6-20 wt % aloe Vera; 6-20 wt % jojoba oil; 6-20 wt % tea tree oil; and 6-20 wt % peppermint oil, all weight percents based on the total weight of the composition.

These and other aspects will become apparent upon reading the following detailed description of the invention.

### DETAILED DESCRIPTION OF THE INVENTION

It has been found that a combination of essential botanical oils, including eucalyptus oil, catnip oil, aloe vera, jojoba oil, tea tree oil, and peppermint oil, is effective in repelling insects from skin or clothing. Use of a combination of botanical oils, when applied to the skin or clothing, is also effective in minimizing the transmission of diseases such as West Nile virus, Lyme disease, Rocky Mountain Spotted Fever, malaria, equine encephalitis, and the like.

As indicated above, the present invention is a topical insect repellent composition, comprising: 40-70 wt % eucalyptus oil; 3-10 wt % catnip oil; 2-6 wt % DMSO or MSM; 6-20 wt % aloe vera; 6-20 wt % jojoba oil; 6-20 wt % tea tree oil; and 6-20 wt % peppermint oil. Each of these components are described in more detail below.

Eucalyptus is an evergreen tree native to Australia but is cultivated worldwide. The oil that is steam-distilled from the eucalyptus leaves have been used medicinally for many years. The major constituent in eucalyptus leaves is a volatile oil known as eucalyptol. In the present invention, eucalyptus oil comprises from about 40 to about 70 wt %, based on the total weight of the composition. A particularly preferred amount of eucalyptus oil is approximately 50 wt %.

Catnip is a whitish-gray plant with a minty odor, and is famous for inducing a delirious, stimulated state in felines. The volatile oil in catnip contains nepetalactone, which is similar to the valepotriates found in valerian, a common herbal sedative. In the composition of the present invention, catnip oil comprises from about 3 to about 10 wt %, based on the total weight of the composition. A particularly preferred amount of catnip oil is approximately 6 wt %.

DMSO (dimethylsulfoxide) and MSM (methylsulfonylmethane) are solvents that aid in the absorption of the botanical oils into the skin. In the present invention, DMSO or MSM preferably comprise from about 2 to about 6 wt %, based on the total weight of the composition. A particularly preferred amount of DMSO or MSM is approximately 4 wt %.

Aloe has been historically used for treatment of cuts and burns on the skin, as well as a skin conditioning agent. In the present invention, aloe vera preferably comprises from about 6 to about 20 wt %, based on the total weight of the composition. A particularly useful amount of aloe vera is approximately 12 wt %.

Jojoba is a plant that grows in many semi-arid regions of the world. The seed-oil has been used in lubricants, cosmetics, pharmaceuticals and as a replacement for sperm oil in manufacturing of inks, varnishes, waxes, detergents, resins and plastics. In the composition of the present invention, jojoba preferably comprises from about 6 to about 20 wt %, based on the total weight of the composition. A particularly preferred amount of jojoba is approximately 12 wt %.

The tea tree grows in Australia and Asia. This tall evergreen tree has a white, spongy bark, and the oil from the leaves has been used medicinally for many years. The oil is known to contain numerous terpenoids. In the composition of the present invention, tea tree oil preferably comprises from about 6 to about 20 wt %, based on the total weight of the composition. A particularly preferred amount of tea tree oil is approximately 12 wt %.

Peppermint is a hybrid of water mint and spearmint. The two main cultivated forms are the black mint, which has violet-colored leaves and stems and a relatively high oil content, and the white mint, which has pure green leaves and a milder taste. The leaves are used medicinally. Peppermint leaves yield approximately 0.1-1.0% volatile oil which is composed primarily of menthol and menthone. In the composition of the present invention, peppermint oil preferably comprises from about 2 to about 6 wt %, based on the total weight of the composition. A particularly preferred amount of peppermint oil is approximately 4 wt %.

The composition of the invention may contain additional/optional additives, such as binders, perfumes, and the like, that are well known in the art. Useful amounts of these optional ingredients generally range from 0.01 to about 20 wt %.

The composition of the invention is prepared by mixing the desired amount of ingredients in a single batch. No particular order of addition of the ingredients is necessary. In addition, the topical composition can be formulated as a solution, suspension, lotion, cream, ointment, gel, film, patch, towelettes, or spray by combining the desired amount of the invention and a suitable base, such as a lotion, cream, ointment, and the like. The desired amount of base incorporated into the composition of the present invention is an amount that does not leave a greasy feel on the skin.

The composition of the invention is preferably packaged in a container along with a label that indicates the composition of the invention is effective for repelling insects from the skin or clothing and instructions for its use, including instructions regarding the proper amount to apply and to various bodyparts (e.g., face, neck, legs, etc.) or clothing n. The composition of the invention may be applied to the skin or clothing in any amount that effectively repels insects, generally in amounts ranging from approximately 50 microliters to approximately 5 milliliters.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A topical insect repellent composition, comprising:
40-70 wt % eucalyptus oil;
3-10 wt % catnip oil;
2-6 wt % DMSO or MSM
6-20 wt % aloe vera;
6-20 wt % jojoba oil;
6-20 wt % tea tree oil; and
6-20 wt % peppermint oil
all weight percents based on the total weight of said composition.

2. The topical insect repellent of claim 1, wherein said eucalyptus oil comprises approximately 50 wt % of said composition.

3. The topical insect repellent of claim 1, wherein said catnip oil comprises approximately 6 wt % of said composition.

4. The topical insect repellent of claim 1, wherein said DMSO or MSM comprises approximately 4 wt % of said composition.

5. The topical insect repellent of claim 1, wherein said aloe vera comprises approximately 12 wt % of said composition.

6. The topical insect repellent of claim 1, wherein said jojoba oil comprises approximately 12 wt % of said composition.

7. The topical insect repellent of claim 1, wherein said tea tree oil comprises approximately 12 wt % of said composition.

8. The topical insect repellent of claim 1, wherein said peppermint oil comprises approximately 4 wt % of said composition.

9. The topical insect repellent of claim 1, further including a base and formulated as a solution, suspension, lotion, cream, ointment, gel, film, patch, towelettes, or spray.

10. An article of manufacture comprising packaging material and a topical insect repellent contained within said packaging material, wherein said topical insect repellent is effective for repelling insects from the skin or clothing, and wherein said packaging material comprises a label which indicates that said topical insect repellent can be used for repelling insects from the skin or clothing, and wherein said topical insect repellent comprises:
40-70 wt % eucalyptus oil;
3-10 wt % catnip oil;
2-6 wt % DMSO or MSM
6-20 wt % aloe vera;
6-20 wt % jojoba oil;
6-20 wt % tea tree oil; and
6-20 wt % peppermint oil
all weight percents based on the total weight of said composition.
